(19) United States
(12) Patent Application Publication
(10) Pub. No.: US 2025/0354733 A1
(43) Pub. Date: Nov. 20, 2025

(54) Dispenser and System for Dispensing from a Canister

(71) Applicant: AC Avalanche LLC, Valley View, OH (US)

(72) Inventors: Theodore Bradley, North Ridgeville, OH (US); Vincent Carrubba, Baldwin, NY (US); Alexander M. Kuo, Dallas, TX (US); Randy Pindor, Fort Lauderdale, FL (US); Gregory L. Skillicorn, Akron, OH (US); Donley Travis Williams, Johnson City, TN (US)

(73) Assignee: AC Avalanche LLC, Valley View, OH (US)

(21) Appl. No.: 19/207,171

(22) Filed: May 13, 2025

Related U.S. Application Data
(60) Provisional application No. 63/647,581, filed on May 14, 2024.
(60) Provisional application No. 63/714,840, filed on Oct. 31, 2024.

(51) Int. Cl. F25B 45/00; B60H 1/00

(52) U.S. Cl. CPC F25B 45/00; B60H 1/00585; F25B 2345/001; F25B 2345/003

(57) ABSTRACT

A dispenser system 12 for a pressurized canister PC including an actuator 60 including components such as an external housing 20, a valve 62 for attachment to an output hose 14 extending downwardly from the valve at angle of less than 90 degrees, a pivoting actuator control or trigger 70, having a return spring 72 to bias the trigger out of engagement with the valve, unless a vent clip sensor 100, 100′ is removed and the trigger is released. The dispenser system 12 having a controller 104 with a timer 26 for measuring and indicating when an additional amount of predetermined time has elapsed following measurements of vehicle vent V air output temperature.

### CROSS-REFERENCE TO RELATED APPLICATIONS

This application claims priority to U.S. Provisional Patent Application Ser. Nos. 63/647,581 filed May 14, 2024 and 63/714,840 filed Oct. 31, 2024, the entireties of which are incorporated herein by reference.

### FIELD OF THE DISCLOSURE

This application relates generally to a dispenser system using actuators and controls for dispensing gas or fluid from pressurized canisters into vehicle air conditioning systems.

### BACKGROUND

Dispensers with actuators are used to control the outflow of gas or fluid products from pressurized containers—such as aerosol cans—particularly for use in connection with recharging air conditioning systems. The actuator is designed to facilitate the gas or fluid flow from the pressurized container to another location, such as a vehicle air conditioner system. The actuator may be designed to release the pressurized gas or fluid from an attached container when the actuator is depressed. When the actuator is released, the actuator stops the release of pressurized gas from the canister. Unfortunately, such systems may be accidently activated during shipment and retail store display. Additionally, the methods used for determining the proper amount of coolant to be added to a vehicle air conditioner system are often complicated for a vehicle owner, and may result in coolant overfilling and possible damage to the vehicle, if not properly controlled. Hose attachments are also inconvenient to ship and store, and can be cumbersome to handle and use. There is a continuing need for improved dispensers and systems for locking the dispenser prior to use, and simplifying the recharging of vehicle air conditioning systems for do-it-yourself (DIY) vehicle owners, as well as for professional mechanics servicing vehicles.

### SUMMARY

The present application provides a dispenser using a temperature sensor to prevent the actuator from operation during shipment and display, and with an improved system using temperature and time to more accurately enable proper recharging of a vehicle air conditioning system.

The dispenser includes an external housing for containing actuator components forming a connection to the canister and operating to control the release of contents from the canister. The system dispenser includes a removable sensor vent clip or temperature sensor vent clip of the type disclosed in U.S. Pat. Nos. 9,933,318, 10,173,492, 11,142,391, D967,785 and U.S. patent application Ser. Nos. 16/945,843, 17/022,996, and 17/684,918, the entirety of which are incorporated herein by reference. The sensor vent clip is provided stored in a sensor holder formed in the dispenser external housing. The sensor vent clip may be a mechanical component, electronic component or other accessory. The sensor vent clip is configured to be removable from the sensor holder in the dispenser. The sensor vent clip serves as a lock or stop to prevent operation of the actuator components prior to removal from the dispenser.

Internal actuator components may include a valve having a stem connector for attachment to an output hose, and a valve stem or fitting for engaging the pressurized canister, a pivoting actuator control or trigger, with a user operating portion positioned above the output hose, and with a pivot joining the trigger and external housing. The trigger and the valve are disengaged, unless the temperature sensor vent clip is removed and the trigger is pivoted into operating engagement under compression of the trigger by a user. A valve return spring 72 biases the valve stem 68 out of engagement with the canister when the trigger is released.

The pivoting actuator control connects within the external housing, and rotates between locked and operating positions. The pivoting actuator control is positioned below the location of the sensor holder for the sensor vent clip, on a side of the canister opposite the optional pressure gauge. When the trigger or actuator control causes the trigger to engage the valve in an operation position, fluid may be provided from the pressurized canister to an output hose. The trigger is designed to be blocked from operation in a locked position by the removable sensor vent clip that serves as trigger lock or stop, housed in locked position in a sensor holder on and through an external surface of the dispenser external housing to prevent use of the dispenser until the sensor vent clip is removed. The trigger lock may be reengaged into locked position within the external housing following dispensing of gas or fluid from the canister.

The dispenser external housing may include a pressure gauge positioned with respect to and in fluid communication with the valve, and opposite the trigger, such that movement of fluid from the canister through the valve to the output hose is always measuring the pressure of the fluid within the can and system during charging of the vehicle air conditioning system. When not charging, the pressure gauge reads the only the system pressure. The pressure gauge provides a measurement feature within the external housing, and may include a display, such as an analog or digital display to show pressures measured. Alternatively, the external housing may be provided without the use of a pressure gauge. The use of a variety of types of sensor vent clip and pressure gauge combinations, enables modular manufacture of multiple products having different price points for serving a variety of retailers and customers.

During operation of the dispenser and system, the sensor vent clip is secured within a vehicle cabin air vent with the AC system preferably turned to, and operated at, the coldest temperature and highest fan speed, and the vehicle doors and windows closed. The sensor vent clip may be an electronic sensor that may electronically communicate with a controller within the dispenser external housing for real-time temperature communication. Where the sensor vent clip is provided as a thermochromic temperature sensor vent clip, the clip changes color as an indication of when to let go of the trigger or stop charging or dispensing fluid from the canister. In the preferred embodiment, the temperature sensor vent clip contains a thermochromic ink that turns blue when the temperature of air provided from the AC system to the vehicle cabin air vent is approximately 55 degrees Fahrenheit. An alternate embodiment may also, or alternatively, use a second temperature sensor vent clip containing a thermochromic ink that turns green when the temperature of air provided from the AC system to the vehicle air vent is approximately 45 degrees Fahrenheit. Each of the blue and green temperature vent sensor clips changes in color indicate recharging of the AC system is substantially complete and not overcharged.

Additionally, the dispenser controller may include an internal timer switch. It has been determined that the length of time the trigger is operated—or the time threshold during which recharging continues, moves the air conditioning system closer to the desired OEM specified charge than may otherwise be obtained using only vent temperature measurements, as described above using the temperature sensor vent clip. The internal timer switch is programmed to add a desired additional amount of charging time after the initial charge, or after which a temperature threshold has been reached, as communicated by the vent sensor clip, and to continue operation of the dispenser until the programmed time is reached. The additional amount of charging time to add may vary depending on a number of factors, including, for example, the condition of the canister, such as temperature and the level of fluid within the canister. Generally, the preferred amount of additional charging time is between approximately 15 seconds and 1 minute, more preferably between 30 and 45 seconds, and most preferably about 30 seconds. With the addition of this small amount of charging time, the user is provided with a more complete refrigerant charge.

A still further advantage of the present dispenser is the addition of a finger rest or hose cover positioned under the operating trigger. The hose is directed in a downward direction at an angle of less than 90 degrees with respect to a central axis of the valve, and from a location under or below the operating trigger, along the dispenser housing. The hose cover is located over the hose to provide a comfortable and natural location to position a user's fingers in order to avoid the fingers getting in between the output hose and the canister, and thereby interfere or limit the range of motion of the trigger. Hose wings are also provided on each side of the dispenser external housing extending outwardly from positions adjacent the temperature sensor for press-fit engagement for storage as desired of the output hose.

Yet another advantage of the present dispenser is the incorporation of a pressure reading algorithm within the digital pressure gauge to advise the user during charging that conditions within the air conditioning system warrant seeking professional service.

### BRIEF DESCRIPTION OF THE DRAWINGS

Embodiments will now be described, by way of example only, with references to the accompanying drawings in which:

FIG. 1 is a schematic rear perspective view of an embodiment of a dispenser system of this application.

FIG. 2 is a schematic, bottom perspective view of an embodiment of the dispenser system of FIG. 1.

FIG. 3 is a schematic rear view of the dispenser system of FIG. 1.

FIG. 4 is a schematic front view of the dispenser system of FIG. 1.

FIG. 5 is a schematic left side view of the dispenser system of FIG. 1.

FIG. 6 is a schematic right side view of the dispenser system of FIG. 1.

FIG. 7 is a schematic top view of the dispenser system of FIG. 1.

FIG. 8 is a schematic bottom view of the dispenser system of FIG. 1.

FIG. 9 is a partial, schematic cut-away side view of certain components of the dispenser system of FIG. 1.

FIG. 10 is an enlarged partial, schematic cut-away left side view of the dispenser of FIG. 9.

FIG. 11 is a schematic, perspective cut-away left side view of the dispenser, similar to FIG. 10.

FIG. 12 is a schematic, perspective cut-away right side view of the dispenser of FIG. 11, and showing the internal timer switch within the housing. FIGS. 13 to 16 are schematic, left side, front, right side and perspective views, respectively, of the dispenser system of the present application.

FIGS. 17 and 18 are schematic left side and perspective top views of and embodiment of the dispenser system using a digital pressure gauge as well as a digital wireless temperature sensor.

FIGS. 19 and 20 are schematic left side and perspective top views of an embodiment of the dispenser system using an analog pressure gauge.

FIGS. 21 and 22 are schematic left side and perspective top views of an embodiment the dispenser system without a pressure gauge.

FIGS. 23 and 24 are schematic exploded perspective views of embodiments of temperature sensor vent clip removed from the dispenser housing.

FIG. 25 is a perspective top view of a thermochromic ink temperature vent sensor housed within a clip and shown after removal by sliding horizontally outwardly from the locked position within the dispenser housing to permit operation of the trigger, and prior to mounting of the vent sensor within the vehicle cabin air vent.

FIG. 26 is a perspective bottom view of the temperature vent sensor of FIG. 25.

FIGS. 27A, 27B and 27C show two thermochromic ink temperature vent sensors mounted within a vehicle cabin air vent, and where prior to detecting the desired air temperature necessary to change the color of the ink as in FIG. 27A, the sensors are a color white, and where the left temperature vent sensor in FIGS. 27B and 27C has changed a blue color by detecting air approximately 55 degrees Fahrenheit, and where the right temperature vent sensor in FIG. 27C has also changed color to a green color by detecting air approximately 45 degrees Fahrenheit, respectively.

FIG. 28 shows a graph indicating the desired temperature zone in which the illustrated temperature vent sensors turn color to indicate when the closed vehicle cabin air temperature from the air vent has been reached and charging of the AC system can be stopped.

### DETAILED DESCRIPTION

While the subject matter of this application may be embodied in many different forms, described here are preferred embodiments with the understanding that the present disclosure is to be considered as an exemplification of the principles described and is not intended to limit the broad aspects described to the embodiments illustrated. It will be understood that the disclosure may be embodied in other specific forms without departing from the spirit or central characteristics thereof. For context, the orientation of the components may be referred to by directions (e.g., top, bottom, right, left, etc.) as shown in the figures. Those skilled in the art will recognize that during use these directions may be changed without changing the relationship between components. The present embodiment, therefore, is to be considered in all respects as illustrative and not restrictive, and not to be limited to the details given herein.

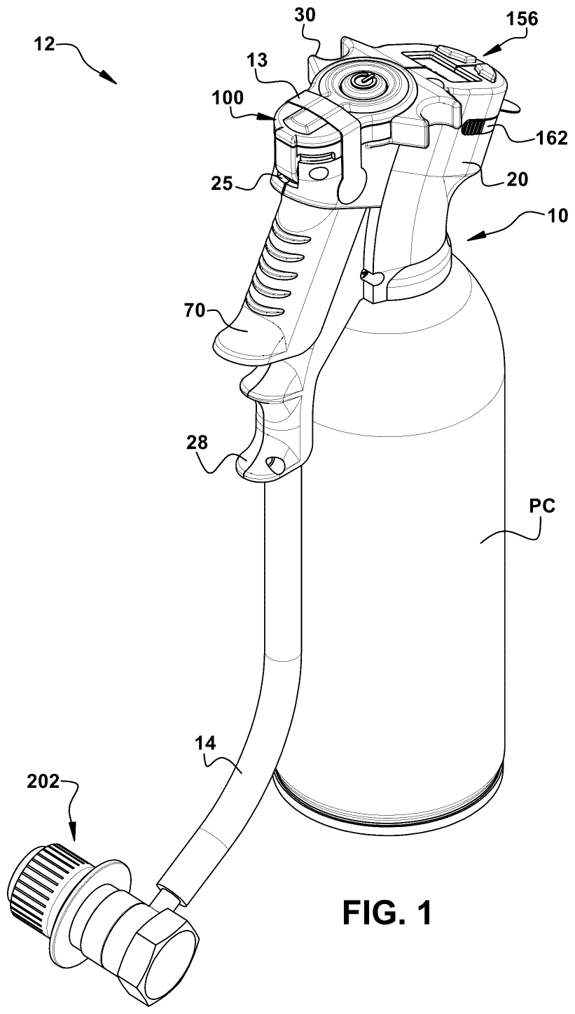

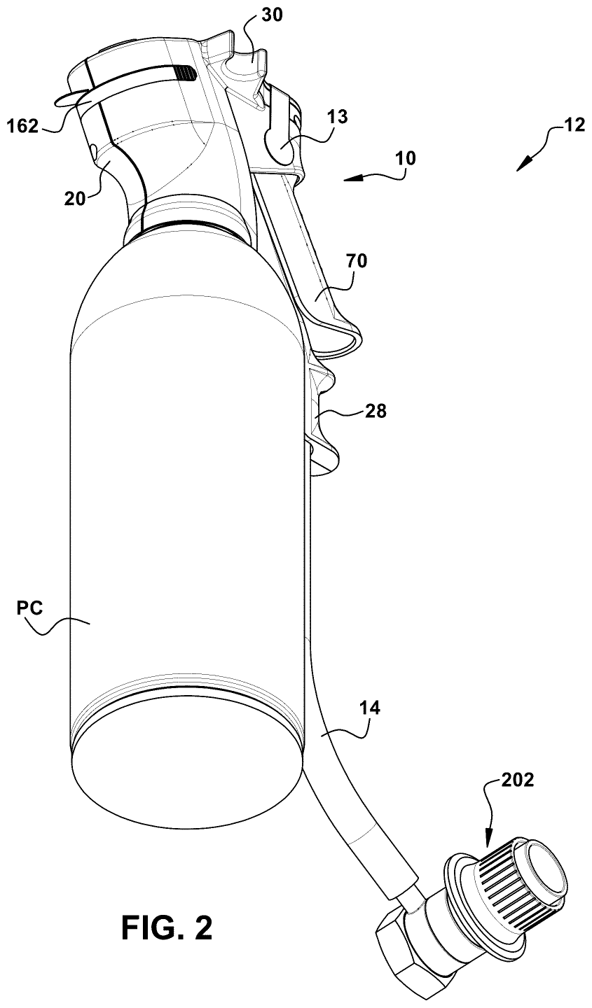

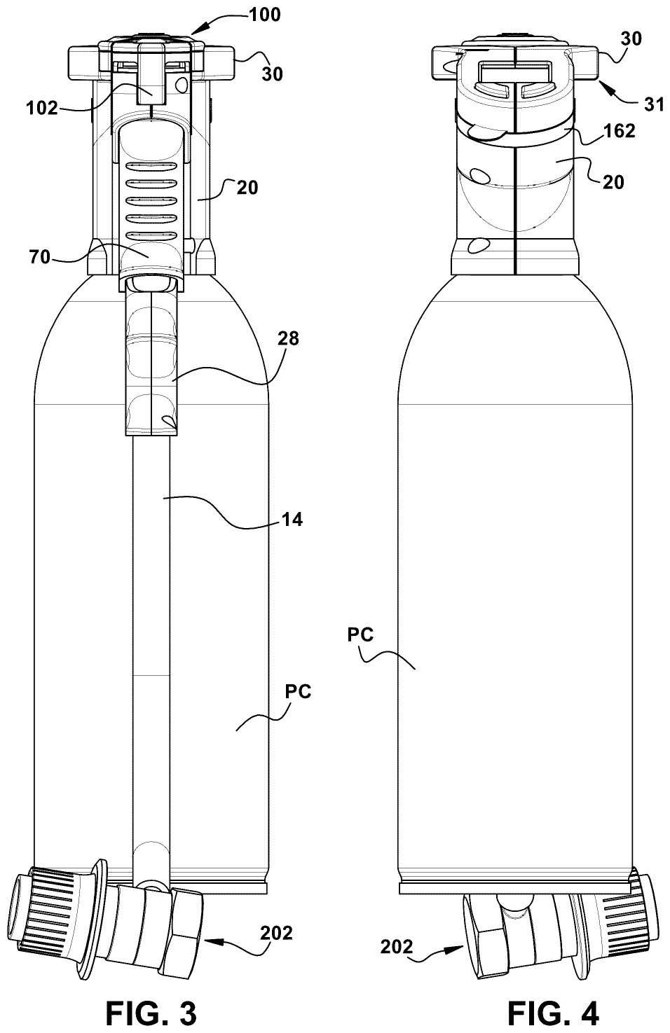

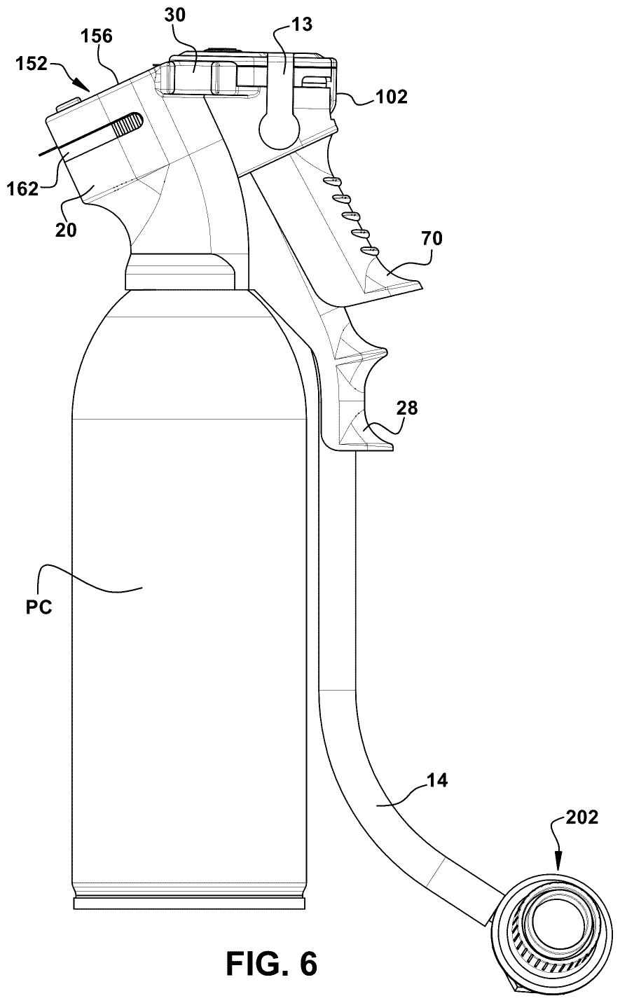

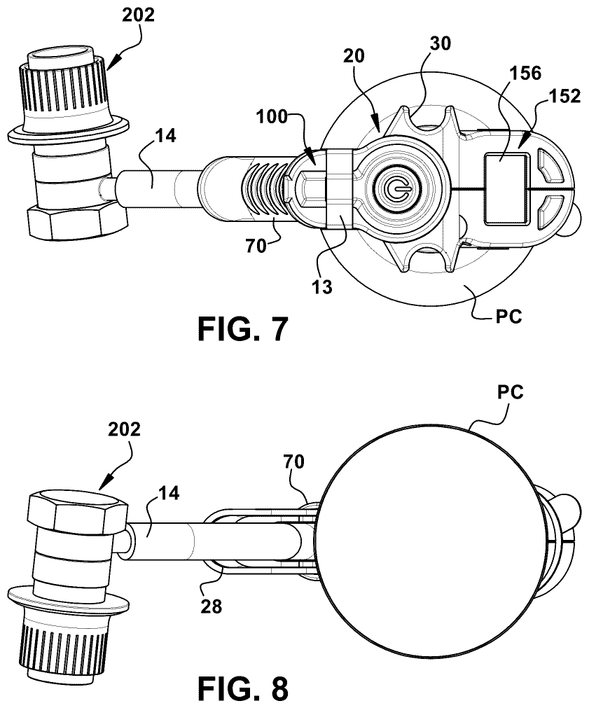

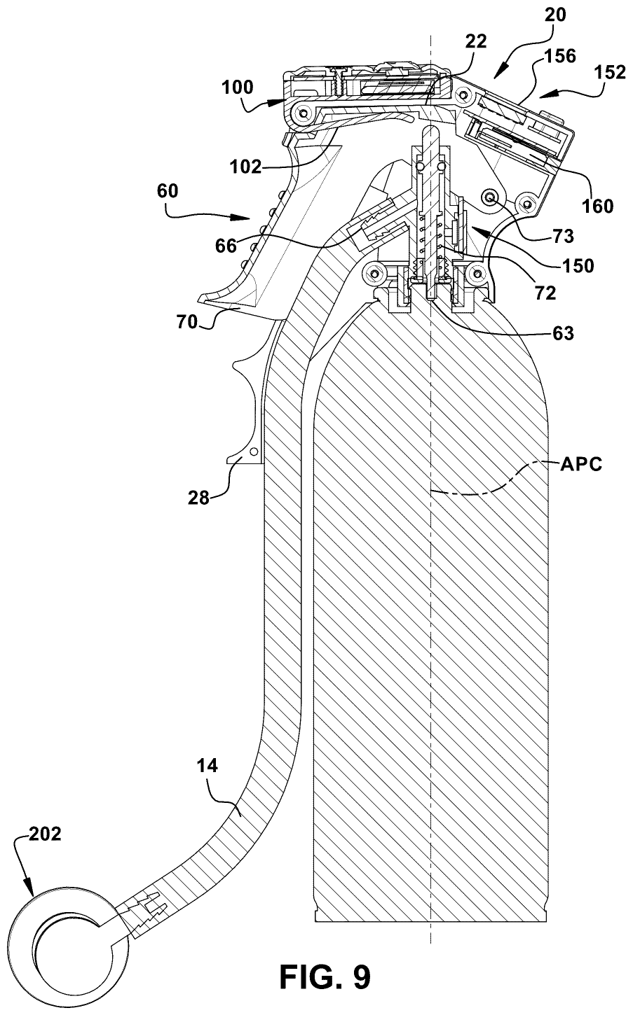

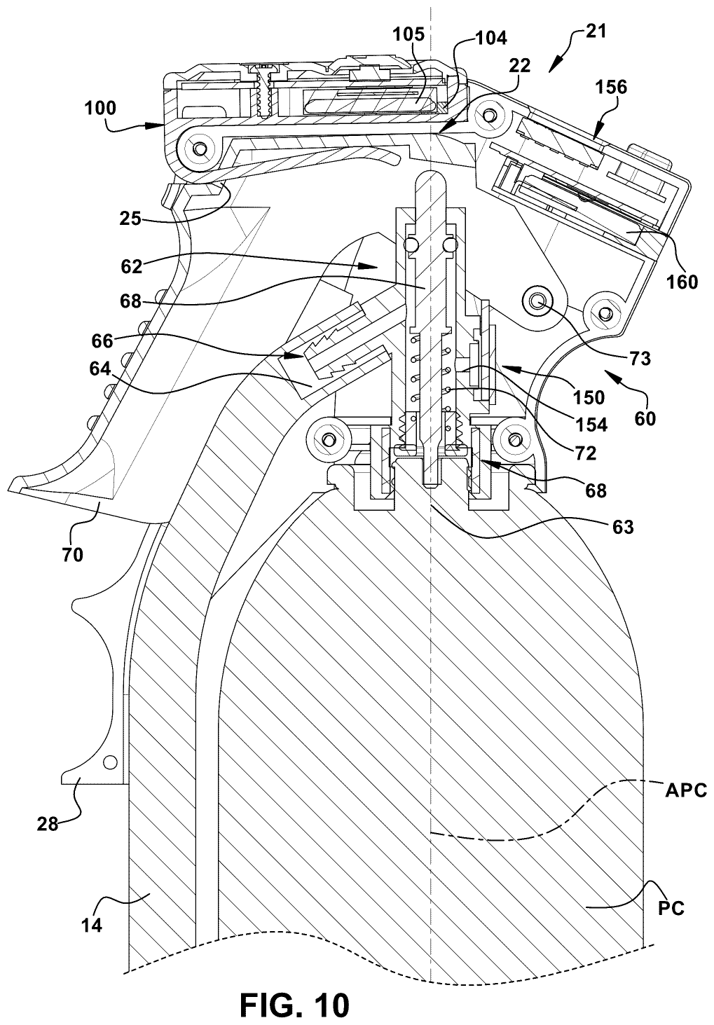

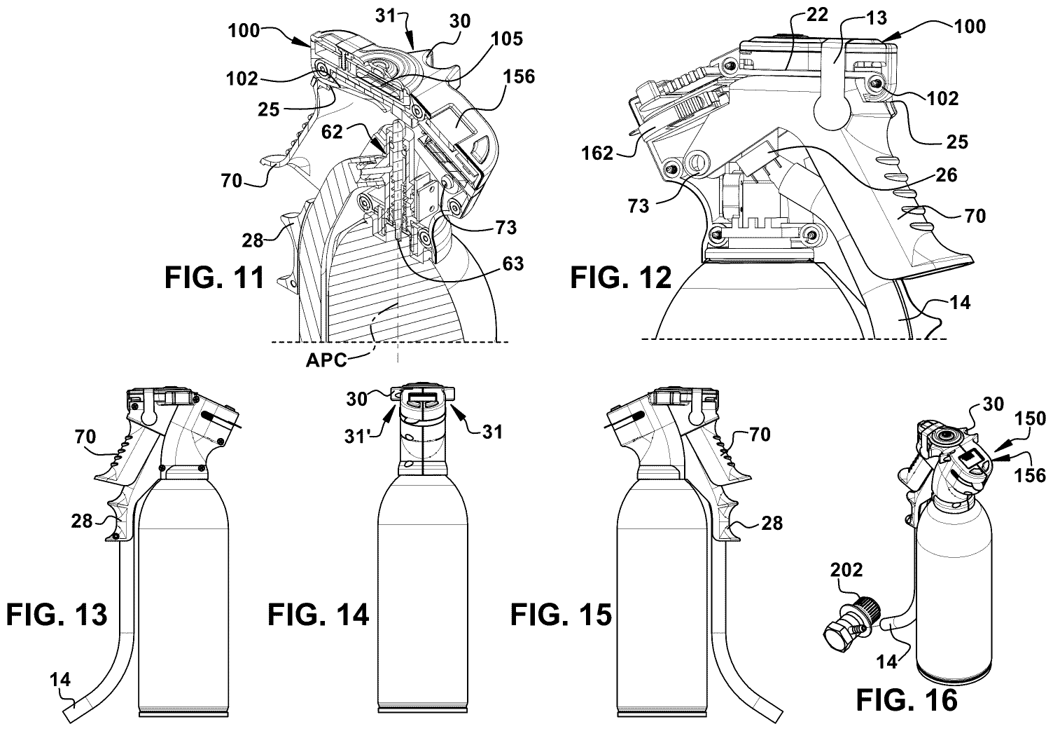

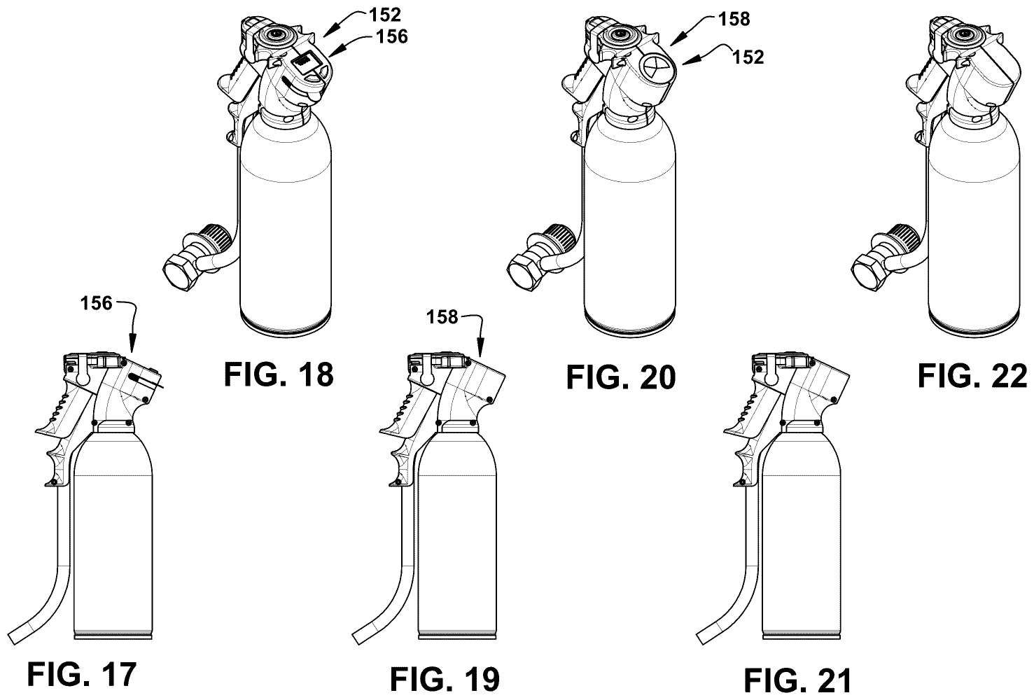

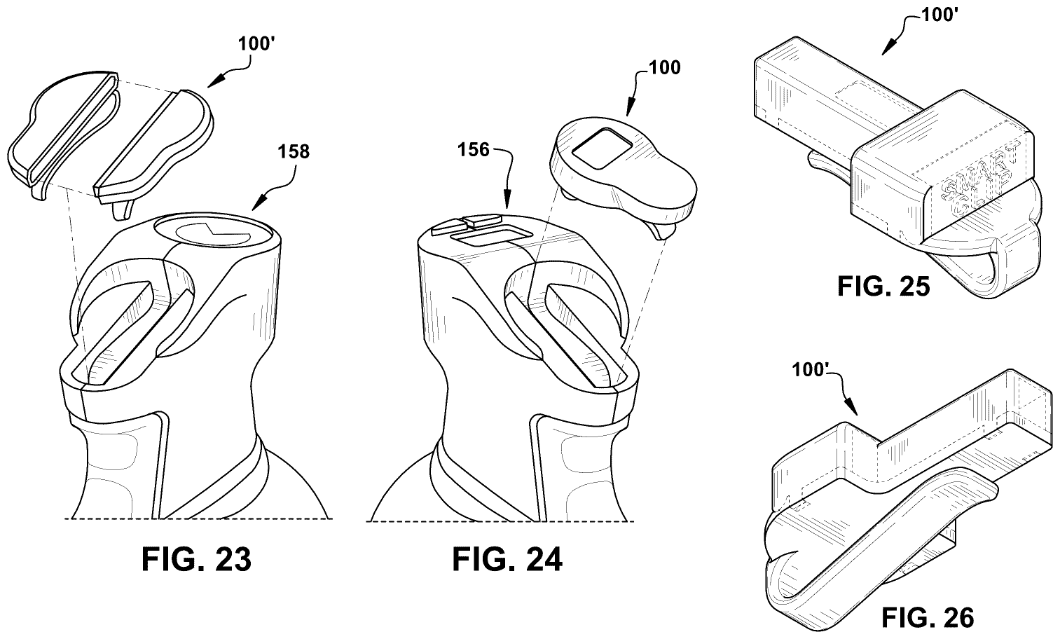

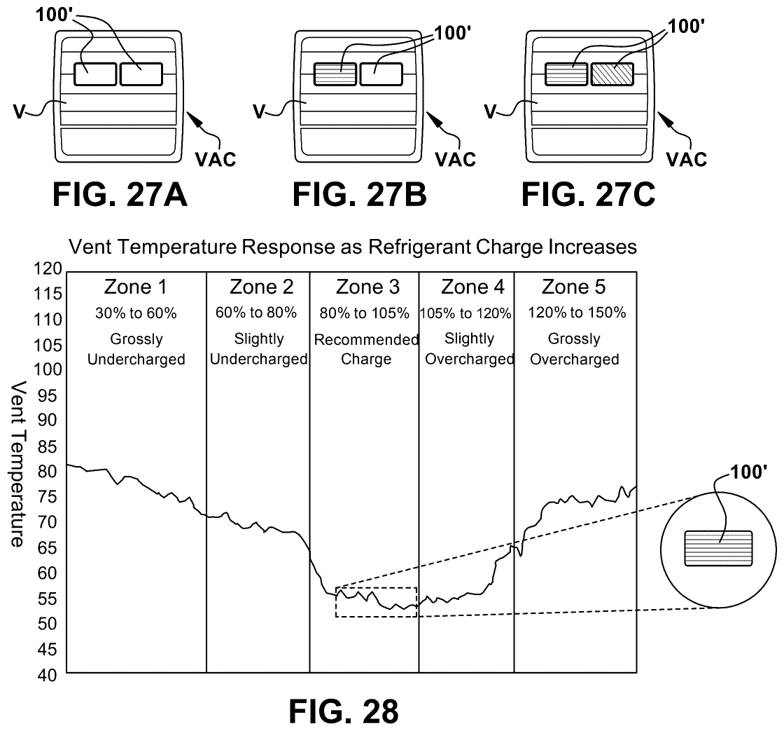

To use the illustrated dispenser 10 and refrigerant charging system 12 in FIGS. 1 to 19, the user removes an optional security sticker 13, and the sensor vent clip 100 or temperature sensor vent clip 100′ from the sensor holder compartment or opening 22 provided in the dispenser external housing 20. The sensor vent clip may be a mechanical component, electronic component, such as a powered RFID with temperature sensor or thermistor 104 (battery 105) in electronic communication with a display 21 within the dispenser external housing, or other accessory. The temperature sensor vent clip serves as a trigger lock or stop to prevent operation of actuator components 60 prior to removal from the dispenser external housing 20. The dispenser external housing 20 includes a slot 25 for receiving a clip leg portion 102 of the sensor vent clip during storage. The sensor vent clip 100, 100′ attaches to a vehicle cabin air vent V, preferably a central vent as illustrated in FIGS. 27A, 27B and 27C. For example, the temperature sensor 100 clip leg portion 102 snaps onto the automobile vent V. The user connects the output hose 14 to the automobile air conditioning system VAC using a dispenser coupler connector 202 at a location for recharging refrigerant into the system VAC.

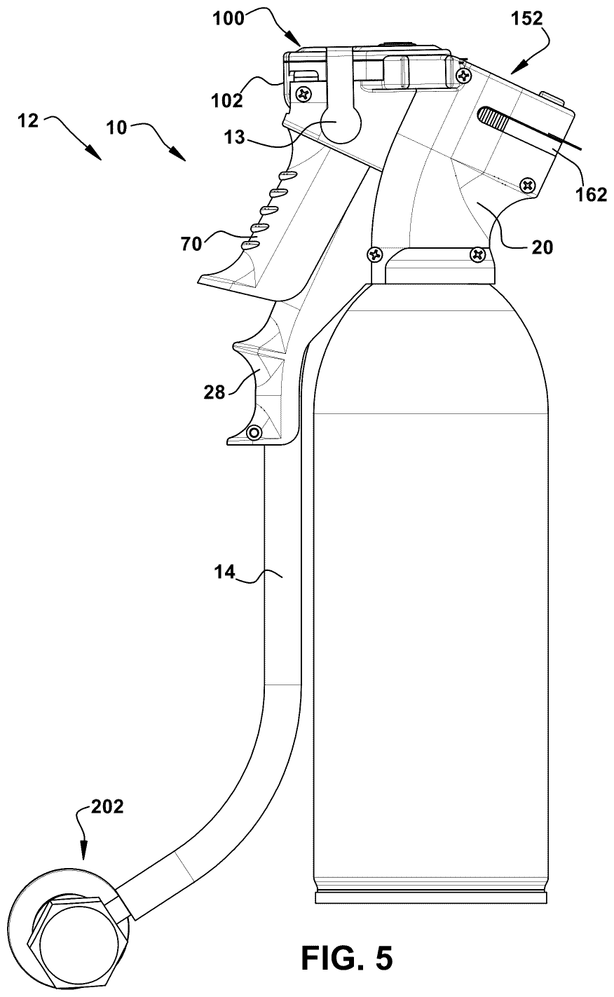

The dispenser external housing includes a substantially U-shaped hose attachment 30 extending from one or both sides 31, 31′ of the dispenser external housing. During storage, the outlet hose 14 is press-fit into engagement with the substantially U-shaped house attachment(s) 30. The output hose 14 is in fluid communication with the canister PC via a valve 62 secured to the canister. The valve 62 has a downward directed exit port 66 for engagement at the stem connector 64 with the outlet hose 14, such that the downwardly directed exit port and the outlet hose extend at an angle of less than 90 degrees with respect to a central axis 63 of the valve, the canister valve stem 68 and a central axis APC of the canister. When extended, the outlet hose 14 may be suspended substantially parallel with the canister, as shown at least in FIGS. 5-6, 13 and 15. Extending from the exit port 66, the outlet hose 14 is positioned at a location between a finger operating portion of a trigger 70 for operating the dispensing apparatus and the canister PC of air conditioning refrigerant. The user may optionally open a monitoring application in the user's electronic mobile device. The electronic mobile device and the sensor vent clip 100, may pair to ensure real-time communication of the vehicle vent air output temperature, and provide instructions to the user regarding when to terminate charging, or when to seek professional advice.

Internal actuator components 60 include the valve 62 with the central axis 63, generally aligned with the central axis APC of the pressurized canister of refrigerant. The valve exit port 66 with stem connector 64 for attachment to the output hose 14, enables communication with the valve stem 68 for receiving fluid from the pressurized canister. The user operating portion of the pivoting actuator control or trigger 70 is positioned on a side of the output hose 14 away from the canister PC. The trigger 70 is engaged within the external housing at a pivot 73, and is disengaged with the valve 62 and valve stem 68, unless the sensor vent clip 100, 100′ is removed, and the trigger 70 is pivoted into operating engagement under compression of the user operating portion of the trigger by a user.

The pivoting actuator control or trigger 70 is connected within the external housing to rotate or pivot between locked and operating positions. The finger surface or the user operating portion of the trigger 70 is positioned below the location of the sensor holder compartment 22 for the sensor vent clip 100, 100′, on a side of the canister opposite the optional pressure gauge 150. When the trigger or actuator control 70 causes the valve 62 to be moved to an operation position, fluid is provided from the pressurized canister to the output hose 14. The trigger 70 is blocked from operation when in a locked position by the removable sensor vent clip 100, 100′ when housed in the sensor holder 22 on and through the slot 25 on an external surface 24 of the dispenser external housing. For storage following dispensing of gas or fluid from the canister, the sensor vent clip may be re-engaged into the locked position within the dispenser external housing.

The external dispenser housing 20 is also provided with a finger rest, finger protector or hose cover 28 positioned under the finger operating portion of the trigger 70. As the outlet hose 14 is directed away from the canister PC in a downward direction at an angle of less than 90 degrees with respect to the central axis 63 of the valve 62, and from a location under or below the trigger, the hose cover 28 is located to provide a comfortable and natural location to position a user's fingers in order to avoid the fingers getting between the output hose 14 and the canister PC during trigger operation. The finger protector or hose cover 28 extends from the external dispenser housing 20 from a position under and below the user operating portion of the trigger 70.

The external housing dispenser 20 includes an optional pressure gauge 150 positioned with respect to and in fluid communication with the valve 62, or an in-line valve. Movement of fluid from the canister through the valve to the output hose is always measuring the pressure of the fluid within the canister and the system VAC during charging of the vehicle air conditioning system. When not charging, the pressure gauge reads the only the system VAC pressure. The pressure gauge provides a display 152 for a measurement feature within the external housing dispenser, and may include either an analog display 158, FIG. 20, or a digital display 156, FIG. 18, to show pressures measured. A dispenser 10 without a pressure gauge is also an option, as in FIG. 22. The use of optional types of either a digital temperature indicator 100 or a thermochromic ink temperature indicator 100′ within a sensor holding compartment 22 within the dispensing apparatus 10, and either a digital pressure gauge, an analog pressure gauge 150 or without a pressure gauge, the dispenser and system enables a modular assembly to accommodate a variety of retail price points and functionality.

During operation of the dispenser 10 and system 12, the temperature sensor vent clip 100, 100′ in FIGS. 25 and 26, is secured within a vehicle cabin air vent V with the AC system preferably turned to, and operated at, the coldest temperature and highest fan speed, and the vehicle doors and windows closed. As shown in FIGS. 27A to 27C, the thermochromic ink temperature sensor vent clip 100′ changes color as an indication of when to let go of the trigger or stop charging or dispensing fluid from the canister. In a preferred embodiment, the temperature sensor vent clip contains a thermochromic ink that turns blue when the temperature of air provided from the AC system to the vehicle cabin air vent is approximately 55 degrees Fahrenheit. An alternate embodiment may also, or alternatively, use a second thermochromic ink temperature sensor vent clip 100′ containing a thermochromic ink that turns green when the temperature of air provided from the AC system to the vehicle air vent is approximately 45 degrees Fahrenheit. Each of the blue and green temperature vent sensor clips changes in color indicate recharging of the AC system is substantially complete and not overcharged. The temperature response of the thermochromic ink temperature vent sensor clips turning blue is indicated in FIG. 28 where the desired Zone 3 of Recommended Charge is between 80% to 105%.

Where the embodiment provides the digital temperature vent sensor 100′ and a digital pressure gauge 150, the external dispenser housing 20 may include an internal timer switch 26. The internal timer switch is programmed to add a desired additional amount of charging time after the initial charge, or after which a vehicle vent outlet air temperature has been reached, and instructions to continue operation of the dispenser until the programmed time is reached are displayed. The preferred amount of additional charging time is between approximately 15 seconds and 1 minute, more preferably between 30 and 45 seconds, and most preferably about 30 seconds. With the addition of this small amount of elapsed charging time following the temperature vent sensor having displayed an indication of having reached a desired vehicle vent air output temperature, recharging is indicated as complete, and the user's vehicle air conditioning system is provided with a more complete refrigerant charge. A power supply or battery 160 stored within a removable battery tray 162 supplies power to the electronic components of the dispenser 10.

The modular embodiment of the digital temperature vent sensor 100 and digital pressure gauge 156, may likewise be programmed to incorporate a pressure reading algorithm within the digital pressure gauge. Upon measuring predetermined pressures and temperatures from the vehicle air conditioning system, the pressure reading algorithm is programmed to provide a display notice to the user that conditions within the vehicle air conditioning system warrant seeking professional service.

With the setup complete, the user or another person may start the automobile and turn the vehicle air conditioning system VAC on to a full fan and highest cold setting, and close the vehicle windows and doors. The user may then begin charging the air conditioning system by operating or squeezing the trigger 70 on the dispenser 10. The user may hold the trigger down while watching the application running on the mobile device, or the user or an assistant may view the temperature sensor vent clip or clips 100, 100′ for color change indications, and/or watch the pressure gauge 150, either the optional digital pressure gauge 156 or analog pressure gauge 158, which function during the charging operation. The optional internal timer switch 26 may operate to add additional charging time to the charging operation, and/or the internal timer switch may provide an indication to the application or digital display 152 to indicate when the air conditioning system VAC is fully charged or complete. Upon observing that the charging operation is complete, the user then releases the trigger 70 of the dispenser 10 to stop charging the system VAC. The application may provide a visual, auditory and/or sensory indication through the dispenser display 152 or through the software application display, speakers or vibratory output on and from the user's mobile device.

The dispenser and system being thus described and further described in the claims, it will be obvious that the same may be varied in many ways. Such variations are not to be regarded as a departure from the spirit and scope set forth herein, and all such modifications as would be obvious to one skilled in the art are intended to be included within the scope of the apparatus described.

1. A method for charging a vehicle coolant system VAC, comprising the steps of:
removing a temperature sensor 100 with a clip 102 from a sensor holding compartment 22 within a dispenser 10 and system 12 for charging a vehicle coolant system VAC from a position wherein the temperature sensor clip 102 blocks operation of the dispenser 10 and system 12 for charging the vehicle coolant system VAC;
installing the temperature sensor 100 in a vehicle air output vent V of the vehicle coolant system VAC inside the vehicle;
removing a hose 14 of the dispenser and system from press-fit engagement with an external dispenser housing attachment location 30;
installing the hose 14 of the dispenser 10 and system 12 at a coolant port in the vehicle coolant system VAC for receiving refrigerant via the hose 14 and an interconnected canister PC of refrigerant, which hose 14 extends from the dispenser 10 in a downward direction, and at an angle of less than 90 degrees, such that the extended hose 14 is substantially parallel with the interconnected canister PC;
operating the vehicle, and operating the vehicle coolant system VAC at settings to provide air from the vehicle air output vent V of the vehicle coolant system at a high blower and coldest temperature level to the vehicle with the vehicle windows and doors closed;
commencing filling of refrigerant by operating the dispenser 10 and system 12 for charging the vehicle coolant system VAC at the coolant port using a trigger 70 positioned above the location where the hose 14 extends 66 from the dispenser 10;
obtaining via the temperature sensor 100, an indication of a temperature of air provided from the vehicle air output vent V during operation; and
terminating filling of refrigerant when the dispenser 10 or temperature sensor 100′ displays an indication of having reached a desired vent air output temperature, and an additional predetermined time of between approximately 15-60 seconds has elapsed.

2. The method for charging a vehicle coolant system VAC of claim 1, where in the step of removing the hose 14 of the dispenser 10 and system 12 from the external dispenser housing attachment location comprises removing the hose 14 from a U-shaped hose wing 30 on a side 30, 31′ of the external dispenser housing 20 adjacent the sensor holding compartment 22.

3. The method for charging a vehicle coolant system of claim 1, wherein the temperature sensor 100 removed from the sensor holding compartment 22 may be a digital temperature sensor 100 in real-time communication with a display 152, 156 in the external dispenser housing 20, or a thermochromic ink temperature sensor 100′.

4. A dispensing apparatus 10 and system 12 for charging an air conditioning refrigerant from a canister PC to a vehicle air conditioning system VAC, the system 12 comprising a temperature indicator 100, 100′ stored, prior to use, within the dispensing apparatus for resisting operation until removed for use from the dispenser apparatus, and an outlet hose 14 extending from the dispensing apparatus in a downward direction, and at an angle of less than 90 degrees with respect to a central axis APC of the canister PC.

5. The claim 4 dispensing apparatus and system for charging an air conditioning refrigerant from a canister PC to a vehicle air conditioning system VAC, wherein the dispensing apparatus 10 further comprises a finger protector 28 positioned below a trigger 70 for operating the dispensing apparatus and covering a portion of the downwardly directed outlet hose 14.

6. The claim 4 dispensing apparatus and system for charging an air conditioning refrigerant from a canister PC to a vehicle air conditioning system VAC, wherein the dispensing apparatus 10 is in fluid communication with the canister PC at a valve 62 secured to the canister PC, the valve 62 having a downward directed exit port 66 for engagement with the outlet hose 14, the downward directed exit port 66 having an angle of less than 90 degrees with respect to a central axis 63 of the valve 62.

7. The claim 5 dispensing apparatus and system for charging an air conditioning refrigerant from a canister PC to a vehicle air conditioning system VAC, wherein the outlet hose 14 for charging air conditioning refrigerant from the canister PC is positioned between the trigger 70 for operating the dispensing apparatus 10 and the canister PC of air conditioning refrigerant.

8. The claim 4 dispensing apparatus and system for charging an air conditioning refrigerant from a canister PC to a vehicle air conditioning system VAC, wherein the dispensing apparatus 10 further comprises a slot 25 for receiving a portion 102 of the temperature indicator 100, 100′ during storage.

9. The claim 4 dispensing apparatus and system for charging an air conditioning refrigerant from a canister PC to a vehicle air conditioning system VAC, wherein the dispensing apparatus 10 comprises a substantially U-shaped hose attachment 30 extending from a side 30, 31′ of the dispensing apparatus 10 for press-fit engagement with an end of the outlet hose 14 during storage.

10. The claim 4 dispensing apparatus and system for charging an air conditioning refrigerant from a canister PC to a vehicle air conditioning system VAC, wherein the dispensing apparatus 10 includes an electronic timer 26 for indicating, and a display 152 for displaying, which electronic timer and display are in real time communication, and the display indicates when an additional predetermined time of between approximately 15-60 seconds has elapsed following the temperature sensor 100, 100′ indicating having reached a desired vehicle vent V air output temperature.

11. The claim 4 dispensing apparatus and system for charging an air conditioning refrigerant from a canister PC to a vehicle air conditioning system VAC, the dispensing apparatus 10 enables a modular assembly for accommodating either a digital temperature indicator 100 or a thermochromic ink temperature indicator 100′ within a sensor holding compartment 22 within the dispensing apparatus 10, and either a digital pressure gauge 156, an analog pressure gauge 158 or without a pressure gauge formed within the dispensing apparatus.
